(19) United States
(12) Patent Application Publication
(10) Pub. No.: US 2002/0024765 A1
(43) Pub. Date: Feb. 28, 2002

(54) Thin film magnetic head and magnetic head assembly employing the same

(75) Inventors: Tomoko Kutsuzawa, Kawasaki (JP); Ikuya Tagawa, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED

(21) Appl. No.: 09/772,216

(22) Filed: Jan. 29, 2001

(30) Foreign Application Priority Data
Aug. 29, 2000 (JP) 2000-258396

(51) Int. Cl. G11B 5/31

(52) U.S. Cl. 360/126

(57) ABSTRACT

An upper magnetic pole layer extends forward over the surface of a non-magnetic gap layer from the central position of a swirly coil pattern. The upper magnetic pole layer is designed to get narrower in the forward direction so as to reach a medium-opposed surface at its tip end. A front magnetic pole piece is defined at the tip end of the upper magnetic pole layer. The front magnetic pole piece extends forward by a constant core width over the surface of the non-magnetic gap layer. The neck height near the trailing side can be defined by a length of the edges or ridgelines extending in parallel near the trailing side on the front magnetic pole piece. The upper magnetic pole layer starts getting broader in the core width from the position defined by the neck height. The reduction in the neck height near the trailing side below 1.0 μm, leads to a reduced leakage of the magnetic field from the trailing edges of the exposed surface of the upper magnetic pole layer at the medium-opposed surface.

### BACKGROUND OF THE INVENTION

1. Field of the Invention

The present invention relates to a thin film magnetic head in general employed in a magnetic recording medium drive or magnetic storage device such as a magnetic disk drive and a magnetic tape drive, for example.

2. Description of the Prior Art

A thin film magnetic head is in general employed to write information data into a magnetic recording medium or disk in a hard disk drive (HDD), for example. The thin film magnetic head is designed to include upper and lower magnetic pole layers allowing their tip ends to get exposed at the medium-opposed or bottom surface of a head slider. A magnetic flux is exchanged between the tip ends of the upper and lower magnetic pole layers. A non-magnetic gap layer interposed between the upper and lower magnetic pole layers serves to leak the exchanged magnetic flux at the medium-opposed surface of the head slider. An induced magnetic field leaked from the medium-opposed surface can be utilized to write or record magnetic binary data into the magnetic recording disk.

The exposed surface of the upper magnetic pole layer at the medium-opposed surface is in general described by a square or rectangular contour. The magnetic flux leaked from the exposed surface at a pair of corners near the leading or upstream side is supposed to greatly contribute to generation of a magnetic field for recordation. The thus induced magnetic field serves to define the width of recording tracks over the surface of the magnetic recording disk. On the other hand, the leakage of a magnetic flux should be suppressed from the exposed surface at a pair of corners near the trailing or downstream side. An increased quantity of the magnetic flux leaked from the trailing corners of the square or rectangle is supposed to induce recordation of erroneous data such as a reversal of binary data and/or an erroneous overwriting or erasure of data.

In general, the upper magnetic pole layer includes a primary magnetic core layer extending forward from the central position of a swirly coil pattern, and a front magnetic pole piece extending forward from the tip end of the primary magnetic core layer over a specific datum plane. The primary magnetic core layer gets narrower toward the tip end coupled to the front magnetic pole piece of a constant width. The front end of the front magnetic pole piece is exposed at the medium-opposed surface of the head slider. The shorter the longitudinal size of the front magnetic pole piece, in other words, the neck height of the upper magnetic pole layer becomes, the larger or stronger magnetic field for recordation can be obtained in the thin film magnetic head. However, this is the fact that a reduction in the longitudinal size of the front magnetic pole piece is believed to inevitably induce an increased quantity of the magnetic flux leaked from the exposed surface of the upper magnetic pole layer at the corners near the trailing side.

If the tip end of the upper magnetic pole layer can be narrowed, a still higher recording density can be achieved in a magnetic recording medium. However, such a narrower or smaller exposed surface of the upper magnetic pole layer is expected to reduce the magnetic field for recordation. The magnitude of the magnetic field required to record magnetic binary data simply relies on the performance or character of the magnetic recording medium. The magnetic field of a sufficient magnitude should be induced for recordation so as to reliably write magnetic binary data into the magnetic recording medium.

### SUMMARY OF THE INVENTION

It is accordingly an object of the present invention to provide a thin film magnetic head capable of greatly contributing to generation of an increased magnetic field for recordation while suppressing a leakage of a magnetic flux from an exposed surface of the upper magnetic pole layer at corners near the trailing side.

According to the present invention, there is provided a thin film magnetic head comprising: a non-magnetic gap layer; an insulating layer extending over the non-magnetic gap layer; a swirly coil pattern embedded in the insulating layer; a lower magnetic pole layer extending below the non-magnetic gap layer from the central position of the coil pattern so as to expose a tip end at a medium-opposed surface; and an upper magnetic pole layer extending from the central position of the coil pattern over the surface of the insulating layer so as to expose a tip end at the medium-opposed surface, wherein the neck height of the upper magnetic pole layer near the trailing side is set equal to or less than 1.0 μm.

In general, the upper magnetic pole layer includes a primary magnetic core layer extending forward toward the medium-opposed surface and a front magnetic pole piece coupled to the front tip end of the primary magnetic core layer so as to extend over the planar surface. The primary magnetic core layer is designed to get narrower in the forward direction. The front magnetic pole piece is designed to have a constant core width over the planar surface. The front tip end of the front magnetic pole piece is exposed at the medium-opposed surface. The exposed surface of the upper magnetic pole layer or front magnetic pole piece is described by a quadrangle at the medium-opposed surface. When magnetic binary data is to be recorded, the magnetic flux is leaked from the exposed surface at a pair of corners near the trailing or downstream side. The corners are conventionally referred to as trailing edges. An increased quantity of the magnetic flux leaked from the trailing edges is supposed to induce recordation of erroneous data and/or erroneous overwriting or erasure of data. Heretofore, a reduction in the longitudinal size of the front magnetic pole piece is believed to inevitably induce an increased quantity of the magnetic flux leaked from the trailing edges in the technical field of thin film magnetic heads.

The present inventors have carefully reviewed the relationship between the longitudinal size of the front magnetic pole piece, namely, the neck height of the upper magnetic pole layer and the magnitude of the magnetic field leaked from the exposed surface irrespective of the aforementioned common knowledge. The neck height can be represented by the neck height defined by the length of the trailing edges or ridgelines extending in parallel with each other on the front magnetic pole piece. As conventionally known, the neck height defines the distance between the medium-opposed surface and the point where the upper magnetic pole layer starts getting broader in the core width. The present inventors have found that a reduction in the neck height below the threshold of 1.0 μm leads to a reduced leakage of the magnetic field from the trailing edges. The present inventors have confirmed that the reduction of the neck height below 1.0 μm greatly contributes to suppression of the leakage of the magnetic field from the trailing edges. The thin film magnetic head of the present invention thus serves to achieve generation of an increased magnetic field for recordation without increasing the leakage of the magnetic field from the trailing edges.

The neck height near the trailing or downstream side may be set smaller than the neck height near the leading or upstream side. In this case, a sectional plane defined at the interface between the front magnetic pole piece and the primary magnetic core layer is set to take an inclined attitude. The sectional plane is allowed to approach the medium-opposed surface at a position remoter from the non-magnetic layer. The inclined attitude greatly contributes to a reliable establishment of an increased magnetic field for recordation and a reliable suppression of the leakage of the magnetic field from the trailing edges.

The upper magnetic pole layer may keep getting narrower toward the tip end at least at a section near the trailing side until the tip end reaches the medium-opposed surface. A pair of trailing edges or ridgelines extending in parallel with each other on the upper magnetic pole piece can completely be eliminated from the upper magnetic pole layer. In other words, the neck height near the trailing side is forced to take a negative value below zero. The elimination of the trailing edges from the front magnetic pole piece leads to a still reliable generation of an increased magnetic field for recordation and a still reliable suppression of the leakage of the magnetic field from the trailing edges.

The thin film magnetic head may further comprise an auxiliary magnetic pole piece disposed between the upper magnetic pole layer and the non-magnetic gap layer so as to extend rearward over the non-magnetic gap layer from a tip end exposed at the medium-opposed surface. The auxiliary magnetic pole piece is designed to have a reduced width smaller than a constant width of the tip end of the upper magnetic pole layer. The auxiliary magnetic pole piece contributes to establishment of a still narrower gap between the upper and lower magnetic pole layers. The narrower gap serves to achieve a still higher recording density of a magnetic recording medium.

The exposed surface of the upper magnetic pole layer at the medium-opposed surface may be described by a lower side or leading contour extending by a first width along the boundary between the non-magnetic gap layer and the upper magnetic pole layer, and an upper side or trailing contour extending by a second width larger than the first width. This exposed surface contributes to establishment of a narrower gap without inducing an excessive reduction in the sectional area of the upper magnetic pole layer. A larger sectional area of the upper magnetic pole layer contributes to generation of an increased magnetic field for recordation.

The thin film magnetic head of the present invention may be incorporated within a magnetic head assembly. The magnetic head assembly may include a head slider supporting the thin film magnetic head and an elastic head suspension carrying the head slider for cantilevered movement.

### BRIEF DESCRIPTION OF THE DRAWINGS

The above and other objects, features and advantages of the present invention will become apparent from the following description of the preferred embodiments in conjunction with the accompanying drawings, wherein:

FIG. 1 is a plan view schematically illustrating the structure of a hard disk drive (HDD);

FIG. 2 is an enlarged perspective view of a flying head slider according to a specific example;

FIG. 3 is an enlarged plan view schematically illustrating the structure of a magnetic core included in a thin film magnetic head or inductive electromagnetic transducer according to a first embodiment of the present invention;

FIG. 4 is a sectional view taken along the line 4-4 in FIG. 3;

FIG. 5 is a front view of a front magnetic pole piece exposed at a medium-opposed or bottom surface of the flying head slider;

FIG. 6 is an enlarged partial perspective view of the magnetic core for illustrating a sectional plane at the interface between the front magnetic pole piece and a primary magnetic core layer;

FIG. 7 is a sectional view taken along the line 7-7 in FIG. 5;

FIG. 8 is a graph illustrating the relationship between the longitudinal size of the front magnetic pole piece, namely, the neck height NH near the trailing side and the magnetic field;

FIG. 9 schematically illustrates the process of producing the thin film magnetic head;

FIG. 10 schematically illustrates the process of producing the thin film magnetic head;

FIG. 11 schematically illustrates the process of producing the thin film magnetic head;

FIG. 12 schematically illustrates the process of producing the thin film magnetic head;

FIG. 13 schematically illustrates the process of producing the thin film magnetic head;

FIG. 14 is an enlarged partial perspective view, corresponding to FIG. 6, for illustrating the structure of a thin film magnetic head or inductive electromagnetic transducer according to a second embodiment of the present invention;

FIG. 15 is an enlarged sectional view schematically illustrating the structure of the magnetic core in the thin film magnetic head according to the second embodiment.

FIG. 16 is an enlarged partial perspective view, corresponding to FIG. 6, for illustrating the structure of a thin film magnetic head or inductive electromagnetic transducer according to a third embodiment of the present invention;

FIG. 17 is an enlarged partial perspective view, corresponding to FIG. 6, for illustrating the structure of a thin film magnetic head or inductive electromagnetic transducer according to a modification to the third embodiment; and

FIG. 18 is an enlarged partial perspective view, corresponding to FIG. 6, for illustrating the structure of a thin film magnetic head or inductive electromagnetic transducer according to a fourth embodiment of the present invention.

### DESCRIPTION OF THE PREFERRED EMBODIMENTS

FIG. 1 schematically illustrates the inner structure of a hard disk drive (HDD) 11 as an example of a recording medium drive or storage device. The HDD 11 includes a box-shaped primary enclosure 12 defining an inner space of a flat parallelepiped, for example. At least one magnetic recording disk 13 is accommodated in the inner space within the primary enclosure 12. The magnetic recording disk 13 is mounted on a driving shaft of a spindle motor 14. The spindle motor 14 is allowed to drive the magnetic recording disk 13 for rotation at a higher revolution speed such as 7,200 rpm or 10,000 rpm, for example. A cover, not shown, is coupled to the primary enclosure 12 so as to define the closed inner space between the primary enclosure 12 and itself.

A carriage 16 is also accommodated in the inner space of the primary enclosure 12 for swinging movement about a vertical support shaft 15. The carriage 16 includes a rigid swinging arm 17 extending in the horizontal direction from the vertical support shaft 15, and an elastic head suspension 18 fixed to the tip end of the swinging arm 17 so as to extend forward from the swinging arm 17. As conventionally known, a flying head slider 19 is cantilevered at the head suspension 18 through a gimbal spring, not shown. The head suspension 18 serves to urge the flying head slider 19 toward the surface of the magnetic recording disk 13. When the magnetic recording disk 13 rotates, the flying head slider 19 is allowed to receive airflow generated along the rotating magnetic recording disk 13. The airflow serves to generate a lift on the flying head slider 19. The flying head slider 19 is thus allowed to keep flying above the surface of the magnetic recording disk 13 during rotation of the magnetic recording disk 13 at a higher stability established by the balance between the lift and the urging force of the head suspension 18.

When the carriage 16 is driven to swing about the support shaft 15 during flight of the flying head slider 19, the flying head slider 19 is allowed to cross the recording tracks defined on the magnetic recording disk 13 in the radial direction of the magnetic recording disk 13. This radial movement serves to position the flying head slider 19 right above a target recording track on the magnetic recording disk 13. In this case, an electromagnetic actuator 21 such as a voice coil motor (VCM) can be employed to realize the swinging movement of the carriage 16, for example. As conventionally known, in the case where two or more magnetic recording disks 13 are incorporated within the inner space of the primary enclosure 12, a pair of the elastic head suspensions 18 are mounted on a single common swinging arm 17 between the adjacent magnetic recording disks 13.

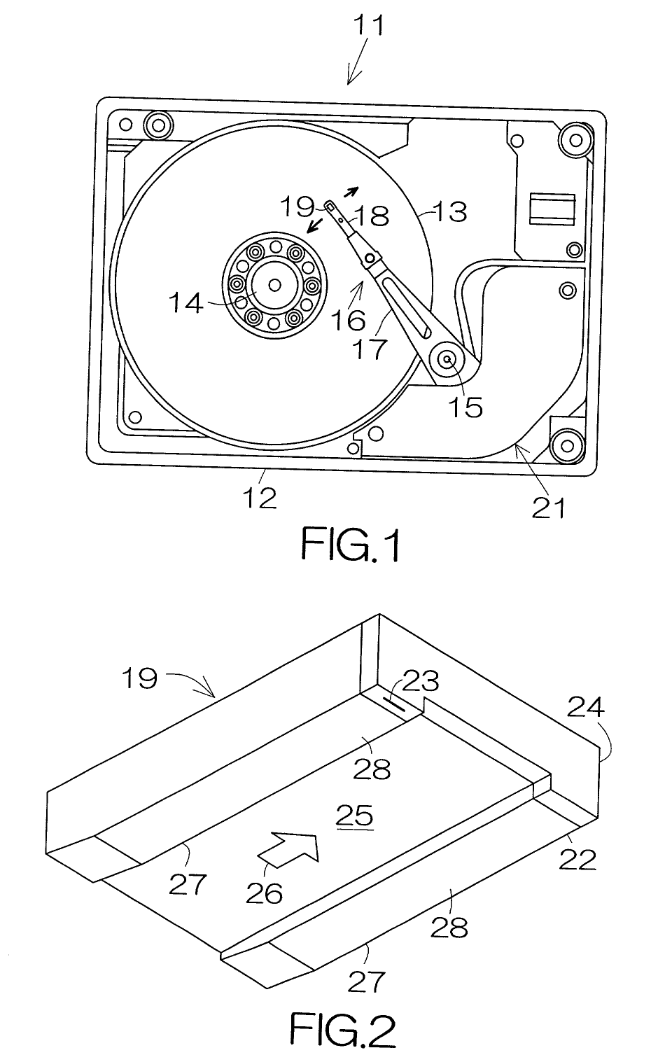

FIG. 2 illustrates a specific example of the flying head slider 19. The flying head slider 19 of this type includes a slider body 22 made from Al₂O₃—TiC in the form of a flat parallelepiped, and a head containing layer 24 coupled to the trailing or downstream end of the slider body 22. The head containing layer 24 may be made of Al₂O₃. A read/write electromagnetic transducer 23 is embedded in the head containing layer 24. A medium-opposed surface or bottom surface 25 is defined continuously over the slider body 22 and the head containing layer 24 so as to face the surface of the magnetic recording disk 13 at a distance. The bottom surface 25 is designed to receive airflow 26 generated along the surface of the rotating magnetic recording disk 13.

A pair of rails 27 are formed to extend over the bottom surface 25 from the leading or upstream end toward the trailing end. The individual rail 27 is designed to define an air bearing surface 28 at its top surface. In particular, the airflow 26 generates the aforementioned lift at the respective air bearing surfaces 28. The read/write electromagnetic transducer 23 embedded in the head containing layer 24 is exposed at the air bearing surface 28 as described later in detail. The flying head slider 19 may take any shape or form other than the above-described one.

As shown in FIG. 3 in detail, the read/write electromagnetic transducer 23 includes an inductive write element or a thin film magnetic head 32 according to a first embodiment of the present invention. The thin film magnetic head 32 is designed to utilize a magnetic field induced at a conductive swirly coil pattern 31 so as to record magnetic binary data into the magnetic recording disk 13. When a magnetic field is induced at the swirly coil pattern 31 in response to supply of an electric current, a magnetic flux is allowed to circulate through a magnetic core 33 penetrating through the swirly coil pattern 31 at its central position.

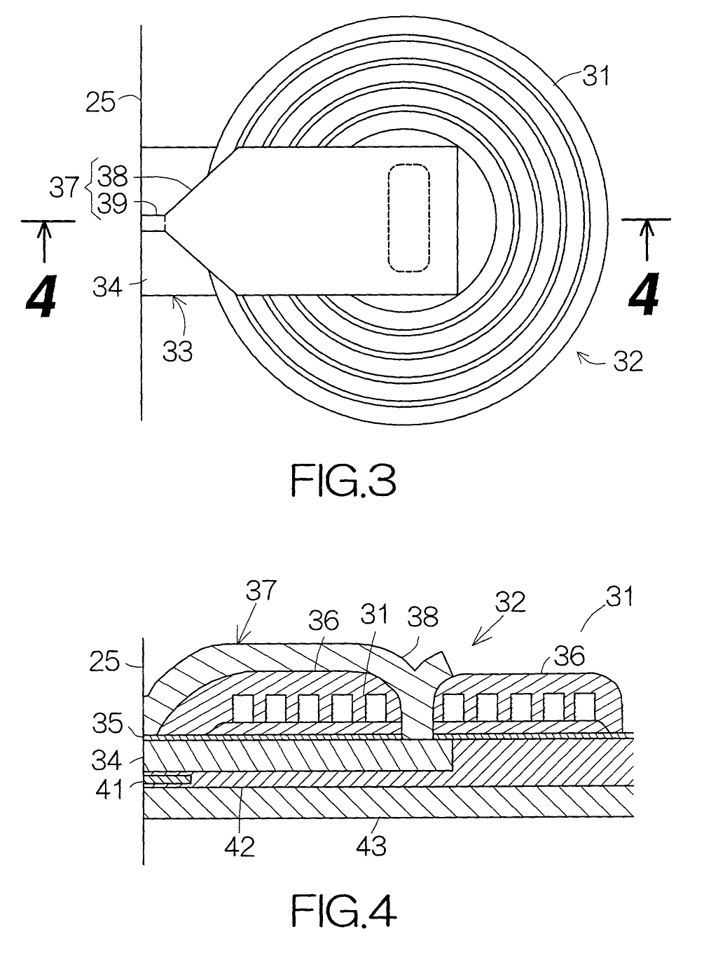

Referring also to FIG. 4, the magnetic core 33 includes a lower magnetic pole layer 34 extending forward over a plane from the central position of the coil pattern 31. The lower magnetic pole layer 34 has its tip end exposed at the bottom surface 25. The lower magnetic pole layer 34 is made from NiFe, for example. A non-magnetic gap layer 35 overlies on the surface of the lower magnetic pole layer 34. The thickness of the non-magnetic gap layer 35 is set at approximately 0.35 μm, for example.

An insulating layer 36 is formed to extend over the non-magnetic gap layer 35. The swirly coil pattern 31 is embedded in the insulating layer 36. The insulating layer 36 is thus allowed to swell from the surface of the non-magnetic gap layer 35. An upper magnetic pole layer 37 is formed to extend forward over the surface of the insulating layer 36 from the central position of the swirly coil pattern 31. The upper magnetic pole layer 37 is made from NiFe, for example. The thickness of the upper magnetic pole layer 37 is set at approximately 4.5 μm, for example.

The upper magnetic pole layer 37 includes a primary magnetic core layer 38 extending forward over the surface of the insulating layer 36 from the central position of the swirly coil pattern 31, and a front magnetic pole piece 39 extending forward from the tip end of the primary magnetic core layer 38 toward the bottom surface 25. The primary magnetic core layer 38 gets narrower toward the tip end near the bottom surface 25. The front magnetic pole piece 39 of a constant width is designed to extend over the planar surface of the non-magnetic gap layer 35. The rear end of the primary magnetic core layer 38 is magnetically connected to the lower magnetic pole layer 34 at the central position of the coil pattern 31.

The front tip end of the front magnetic pole piece 39 is exposed at the bottom surface 25. The non-magnetic gap layer 35 is interposed between the front magnetic pole piece 39 and the front tip end of the lower magnetic pole layer 34, so that the front magnetic pole piece 39 is opposed to the lower magnetic pole layer 34 along the bottom surface 25. The non-magnetic gap layer 35 serves to leak the magnetic flux, exchanged between the front magnetic pole piece 39 and the lower magnetic pole layer 34, out of the bottom surface 25. The leaked magnetic flux forms a magnetic field for recordation.

The thin film magnetic head 32 is formed to extend over the surface of an alumina (Al₂O₃) layer 42. A magnetoresistive (MR) element 41 is embedded within the alumina layer 42. The MR element 41 is employed to read out magnetic binary data out of the magnetic recording disk 13. The alumina layer 42 is interposed between the lower magnetic pole layer 34 of the thin film magnetic head 32 and a lower shield layer 43 made from FeN or NiFe, for example. Specifically, the lower magnetic pole layer 34 functions as an upper shield layer for the MR element 41 in this case. The lower magnetic pole layer 34 is thus allowed to extend over an area wider than the tip end of the upper magnetic pole layer 37 or the front magnetic pole piece 39 near the tip end exposed at the bottom surface 25, as is apparent from FIG. 3, for example. The MR element 41 may be represented by a giant magnetoresistive (GMR) element, a tunnel-junction magnetoresistive (TMR) element, or the like. Alternatively, the thin film magnetic head 32 may solely be employed without the MR element 41.

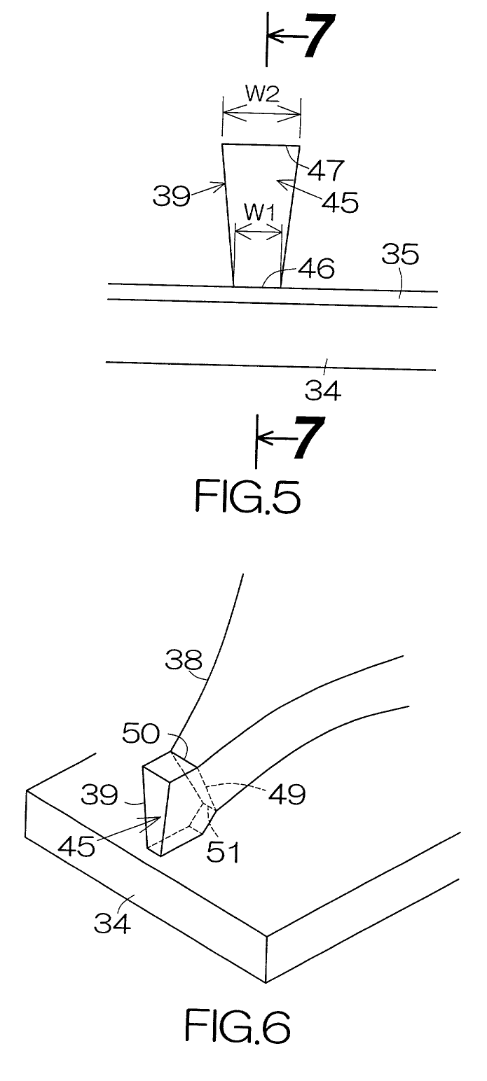

As shown in FIG. 5, the front magnetic pole piece 39 defines an exposed surface 45 at the bottom surface 25. The exposed surface 45 is described by a quadrangular or trapezoidal contour. The quadrangular contour includes at least a leading or lower side contour 46 and a trailing or upper side contour 47 parallel to the lower side contour 46. The lower side contour 46 is designed to extend by a first core width W1, of approximately 1.4 μm, for example, along the boundary between the non-magnetic gap layer 35 and the front magnetic pole piece 39. The upper side contour 47 is designed to extend by a second core width W2, smaller than the first core width W1, of approximately 1.8 μm, for example. The remaining side contours are adapted to define a pair of leading corners at the opposite ends of the lower side contour 46 as well as a pair of trailing corners at the opposite ends of the upper side contour 47. A magnetic flux leaked from the leading corners at the opposite ends of the lower side contour 46 is supposed to define the width of the recording tracks over the magnetic recording disk 13.

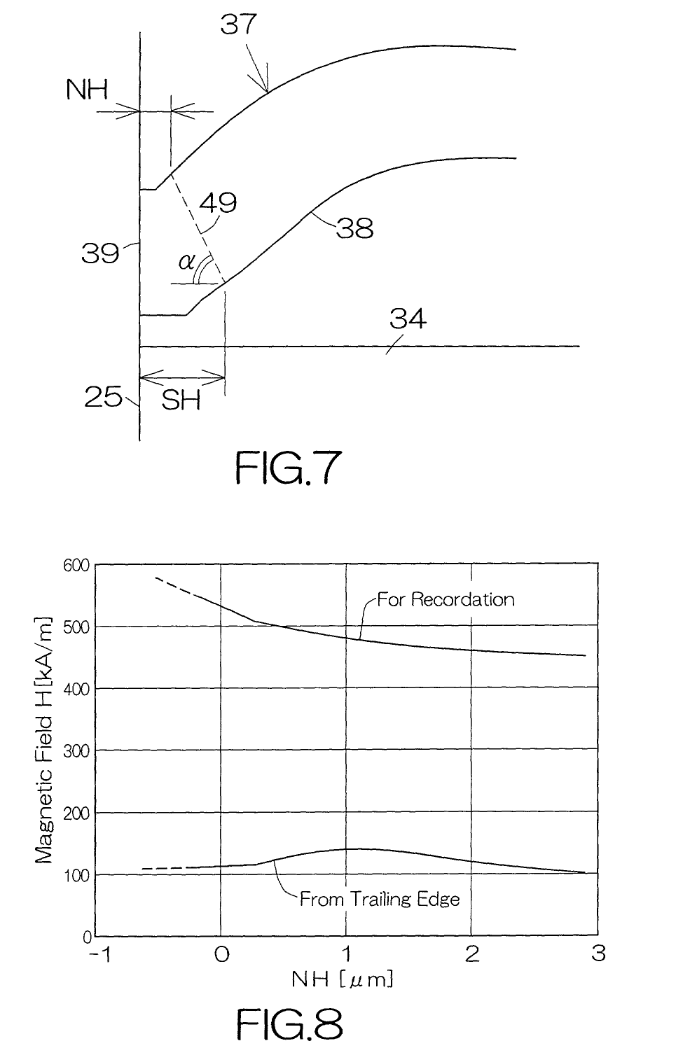

As shown in FIG. 6, the front magnetic pole piece 39 extends rearward keeping the lower and upper core widths W1, W2 at the upper and lower sections, respectively. The primary magnetic core layer 38 is designed to extend rearward so as to increase its lower and upper widths from the first and second core widths W1, W2. A sectional plane 49 can be defined between the front magnetic pole piece 39 and the primary magnetic core layer 38. The sectional plane 49 is described by an upper side contour 50 and a lower side contour 51 parallel to the upper side contour 50 in the same manner as the aforementioned exposed surface 45. Specifically, the sectional plane 49 of a quadrangle or trapezoid can be established. Here, the sectional plane 49 is allowed to take an inclined attitude by an inclined angle α so as to approach the bottom surface 25 at the upper side contour 50, as is apparent from FIG. 7. The sectional plane 49 gradually approaches the bottom surface 25 at a position remoter from the non-magnetic gap layer 35.

The upper magnetic pole layer 37 sets the distance between the sectional plane 49 and the bottom surface 25, in particular, the neck height NH near the trailing side at a dimension equal to or less than 1.0 μm. As shown in FIG. 7, the neck height NH may be measured between the bottom surface 25 and the upper side contour 50 closest to the bottom surface 25. Here, the neck height NH is set at 0.3 μm, while the neck height SH near the leading side is set at 1.0 μm, for example. The neck height SH may be measured between the bottom surface 25 and the lower side contour 51 remotest from the bottom surface 25. As conventionally known, the neck height NH, SH defines the distance between the medium-opposed or bottom surface 25 and the point where the upper magnetic pole layer 37 starts getting broader in the core width.

Now, when an electric current is supplied to the swirly coil pattern 31 in the thin film magnetic head 32, a magnetic field is induced in the swirly coil pattern 31 at the central position thereof. A magnetic flux is thus allowed to circulate through the upper and lower magnetic pole layers 37, 34. The non-magnetic gap layer 35 serves to leak the magnetic flux from the front magnetic pole piece 39 out of the bottom surface 25. The leaked magnetic flux forms the magnetic field for recordation at the bottom surface 25. The magnetic field magnetizes the magnetic recording disk 13 opposed to the bottom surface 25 at a distance. A recording track of the width corresponding to the first core width W1 of the front magnetic pole piece 39 can be defined over the surface of the magnetic recording disk 13.

It is preferable to reduce the first core width W1 of the front magnetic pole piece 39 in the thin film magnetic head 32. A reduced first core width W1 enables a still higher recording density of the magnetic recording disk 13. On the other hand, the reduction in the first core width W1 also induces a reduction in the sectional area of the front magnetic pole piece 39. The reduction in the sectional area may lead to a reduced magnitude of the magnetic field for recordation. A sufficient magnitude should be obtained in the magnetic field for recordation in correspondence with the performance or character of the magnetic recording disk 13. A reliable recordation of magnetic binary data cannot be achieved without a sufficient magnitude. As conventionally known, a reduced longitudinal size of the front magnetic pole piece 39 is expected to increase the magnitude of the magnetic field for recordation.

In general, the thin film magnetic head 32 tends to suffer from the leakage of the magnetic field from the exposed surface 45 at the trailing or downstream corners at the opposite ends of the upper side contour 47. The corners are in general referred to as trailing edges. An increased quantity of the leakage of the magnetic field from the trailing edges is supposed to induce recordation of erroneous data such as a reversal of binary data and/or an erroneous overwriting or erasure of data. Heretofore, a reduction in the longitudinal size of the front magnetic pole piece 39 is believed to inevitably induce an increased quantity of the magnetic flux leaked from the trailing edges in the technical field of thin film magnetic heads.

The present inventors have carefully reviewed the relationship between the longitudinal size of the front magnetic pole piece 39, namely, the neck height KH of the upper magnetic pole layer 37 and the magnitude of the magnetic field leaked from the exposed surface 45, irrespective of the aforementioned common knowledge. The present inventors have found and demonstrated that a reduction in the neck height NH below the threshold of NH=1.0 μm leads to a reduced leakage of the magnetic field from the trailing edges, as shown in FIG. 8. Their demonstration has revealed that the reduction of the neck height NH greatly contributes to suppression of the leakage of the magnetic field from the trailing edges.

In demonstration, the present inventors have utilized implementation of a commercial three-dimensional magnetic field analysis simulator on a computer. A magnetomotive force was set at 0.5 A in the analysis simulator. The magnetic field was measured at a plane spaced by 45 nm from the bottom surface 25. In measurement, the inventors gradually decreased the neck height NH from 3.0 μm. The difference of 0.7 μm was maintained between the neck height NH near the trailing side and the neck height SH near the leading side. SH=NH+0.7 μm was always established. Any other dimensions were established in the above-described manner.

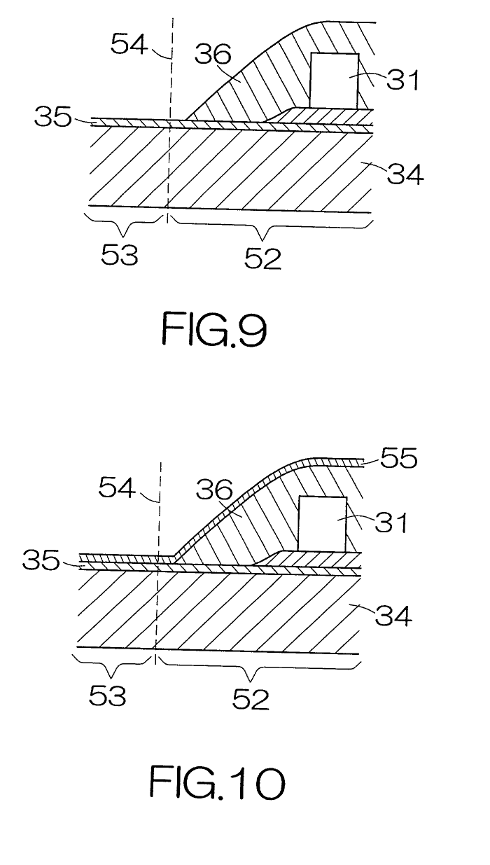

Next, a brief description will be made on a method of producing the thin film magnetic head 32. The lower shield layer 43, the MR element 41 and the alumina layer 42 containing the MR element 41 on the lower shield layer 43 is first formed in a conventional manner on the surface of a wafer comprising an Al₂O₃—TiC substrate and an Al₂O₃ (alumina) lamination covering over the Al₂O₃—TiC substrate. As shown in FIG. 9, a primary section 52 and a marginal section 53 are defined in the wafer. The primary section 52 will be finally cut out into the slider body 22. The marginal section 53 is designed to suffer from abrasion during formation of the bottom surface 25 of the cut out slider body 22. The boundary 54 between the primary and marginal sections 52, 53 may be displaced depending on the quantity of the abrasion, as described later in detail.

As conventionally known, the lower magnetic pole layer 34 is then formed on the alumina layer 42 so as to extend over the primary and marginal sections 52, 53. The non-magnetic gap layer 35 is thereafter formed to cover over the surface of the lower magnetic pole layer 34. The swirly coil pattern 31 and the insulating layer 36 are then formed on the non-magnetic gap layer 35 in a conventional manner.

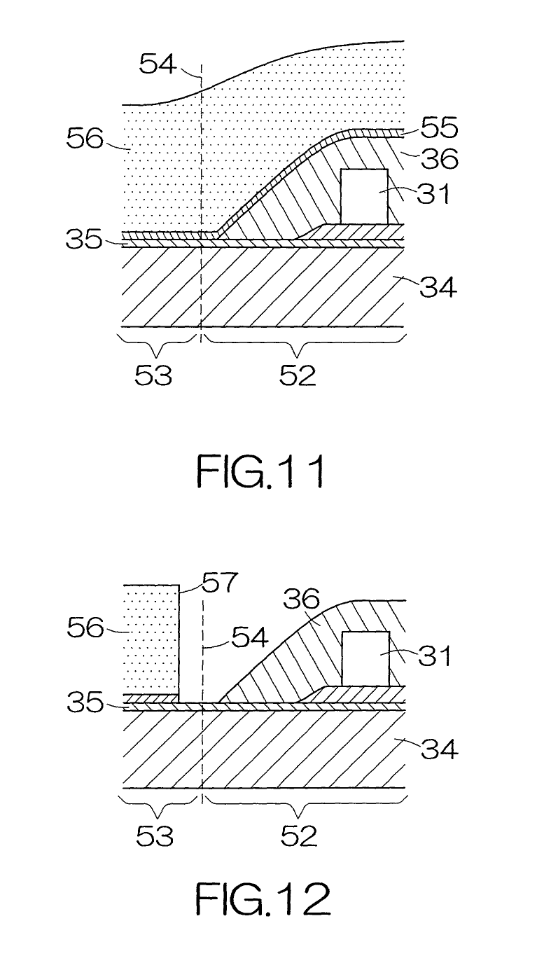

As shown in FIG. 10, a reflection preventing coating 55 is formed to overlie on the non-magnetic gap layer 35 and the insulating layer 36. Sputtering process may be employed to form the reflection preventing coating 55, for example. A photoresist 56 is then applied to the surface of the reflection preventing coating 55, as shown in FIG. 11. The photoresist 56 is subjected to exposure and development below a suitable mask for patterning the contour of the upper magnetic pole layer 37 continuously over the primary and marginal sections 52, 53. After the exposure and development, the photoresist 56 forms a void 57 corresponding to the shape of the upper magnetic pole layer 37, as shown in FIG. 12. The reflection preventing coating 55 exposed at the void 57 is then removed.

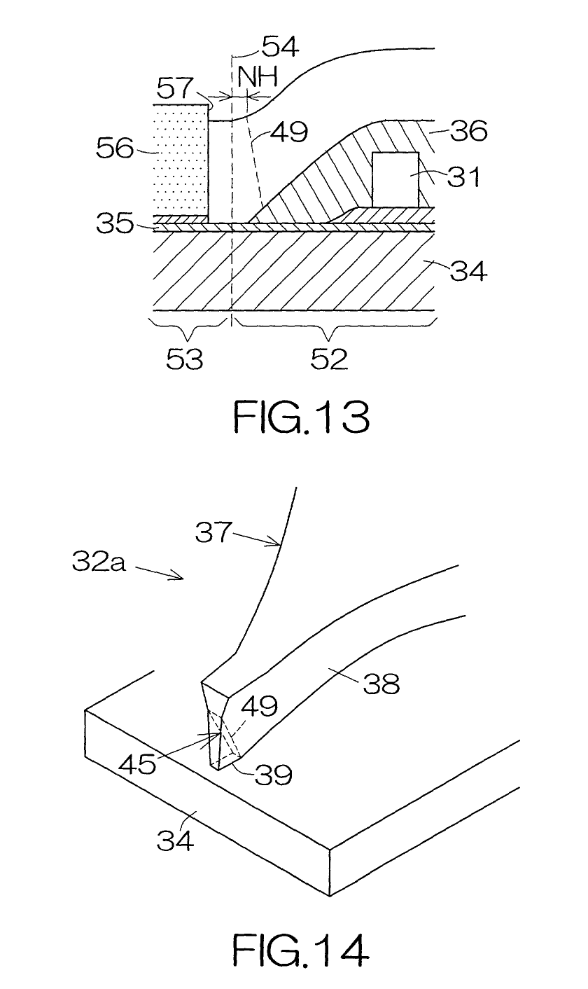

As shown in FIG. 13, the upper magnetic pole layer 37 is deposited in the void 57. An electroplating may be employed to form the upper magnetic pole layer 37, for example. The formed upper magnetic pole layer 37 is covered with an alumina layer, not shown. The thus formed alumina layer interposes the thin film magnetic head 32 and the MR element 41 between itself and the alumina lamination, not shown, previously formed over the wafer. The alumina layer and the alumina lamination forms the aforementioned head containing layer 24.

The individual flying head slier 19 is cut out of the wafer. As conventionally known, the marginal section 53 is scraped off from the cut out slider body 22 in shaping the bottom surface 25. The neck height NH of the upper magnetic pole layer 37 can finely be adjusted by controlling the amount of abrasion of the marginal section 53. The neck height NH of an expected dimension can thus be achieved in the thin film magnetic head 32.

FIG. 14 schematically illustrates the thin film magnetic head 32a according to a second embodiment of the present invention. In this embodiment, the upper magnetic pole layer 37 keep getting narrower toward the tip end at a section near the trailing or upstream side until the tip end finally reaches the bottom surface 25. Specifically, the sectional plane 49 defining the interface of the front magnetic pole piece 39 and the primary magnetic core layer 38 intersects the bottom surface 25. The sectional plane 49 may take an inclined attitude by an inclined angle a in the same manner as the aforementioned first embodiment, for example. Like reference numerals are attached to the structures or components similar to those of the aforementioned first embodiment.

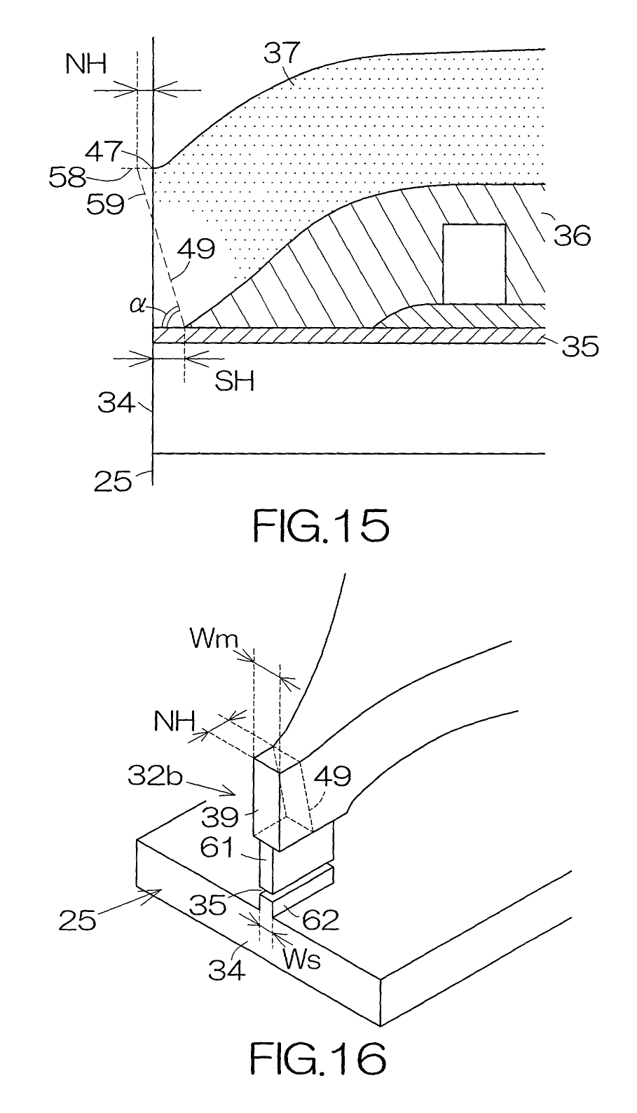

Here, the neck height NH near the trailing side can be defined based on a specific datum plane 58, as shown in FIG. 15. The datum plane 58 intersects the bottom surface 25 at the upper side contour 47 of the exposed surface 45 in the direction normal to the bottom surface 25. The neck height NH can be measured along the datum plane 59 between the bottom surface 25 and the intersection between the datum plane 58 and the extension 59 of the sectional plane 49. The neck height NH is thus allowed to take a negative value below zero (NH<0) in this thin film magnetic head 32a. Since the thin film magnetic head 32a satisfies the aforementioned condition of the neck height NH equal to or less than 1.0 μm, the thin film magnetic head 32a contributes to generation of an increased magnetic field for recordation and a reliable suppression of the leakage of the magnetic field from the trailing edges in the same manner as the aforementioned first embodiment.

FIG. 16 schematically illustrates the thin film magnetic head 32b according to a third embodiment of the present invention. In this embodiment, a smaller upper auxiliary magnetic pole piece 61 is disposed between the upper magnetic pole layer 37, namely, the front magnetic pole piece 39 and the non-magnetic gap layer 35. The upper auxiliary magnetic pole piece 61 is designed to extend rearward over the surface of the non-magnetic gap layer 35 from the tip end exposed at the bottom surface 25. The upper auxiliary magnetic pole piece 61 is forced to have the constant reduced core width Ws, of approximately 0.5 μm, for example. The reduced core width Ws of the upper auxiliary magnetic pole piece 61 is set smaller than the constant first core width Wm (=1.4 μm) of the front magnetic pole piece 39. The upper auxiliary magnetic pole piece 61 serves to establish a smaller or narrower write gap as compared with the front magnetic pole piece 39 solely employed. Like reference numerals are attached to the structures or components similar to those of the aforementioned first and second embodiments.

A smaller write gap greatly contributes to a still higher recording density of the magnetic recording disk 13. In this case, a smaller lower auxiliary magnetic pole piece 62 may likewise be formed on the surface of the lower magnetic pole layer 34. The lower auxiliary magnetic pole piece 62 is designed to extend rearward by the reduced core width Ws over the surface of the lower magnetic pole layer 34 from the tip end exposed at the bottom surface 25. When the lower auxiliary magnetic pole piece 62 is opposed to the upper auxiliary magnetic pole piece 61, a still smaller or narrower write gap can be established at the bottom surface 25.

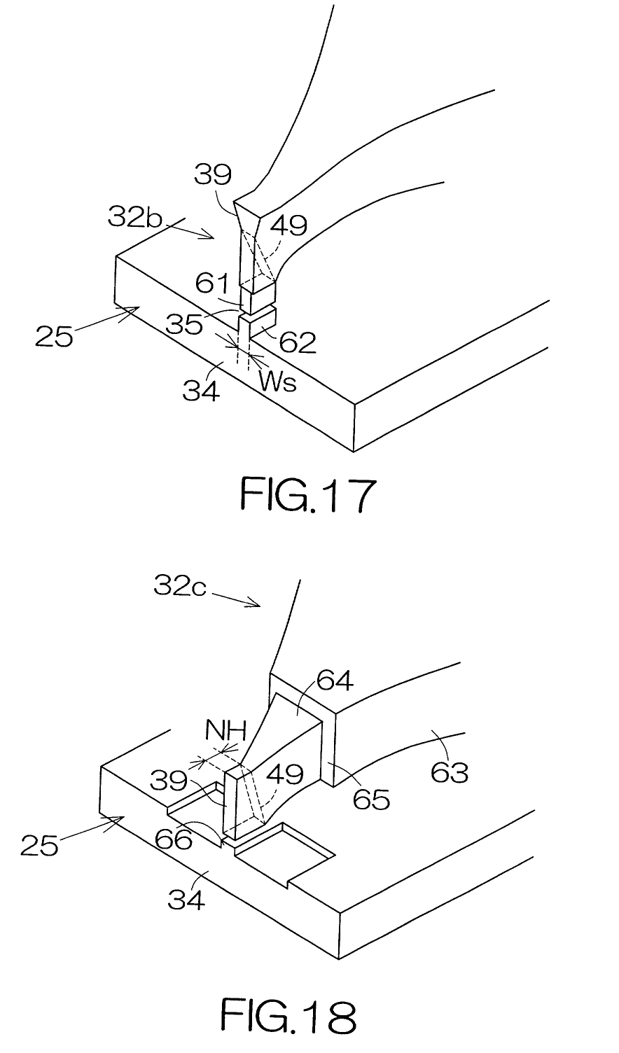

The neck height NH near the trailing side, namely, the distance between the sectional plane 49 and the bottom surface 25 is set equal to or less than 1.0 μm in the thin film magnetic head 32b in the same manner as the aforementioned first embodiment. The leakage of the magnetic field from the trailing edges is thus suppressed in the aforementioned manner. As shown in FIG. 17, the sectional plane 49 may be allowed to intersect the bottom surface 25 in the thin film magnetic head 32b of this type in the same manner as the aforementioned second embodiment, for example.

FIG. 18 schematically illustrates the thin film magnetic head 32c according to a fourth embodiment of the present invention. In this embodiment, the primary magnetic core layer 38 is designed to include a rear main layer 63 extending over the surface of the insulating layer 36 from the central position of the swirly coil pattern 31. The rear main layer 63 gets narrower in the forward direction. A front end layer 64 is connected to the tip end of the rear main layer 63. The front end layer 64 still gets narrower in the forward direction. A step 65 is defined between the rear main layer 63 and the front end layer 64. The step 65 serves to have the front end layer 64 still narrowed. The aforementioned front magnetic pole piece 39 is connected to the still smaller tip end of the front end layer 64. The thin film magnetic head 32c of this type allows the front magnetic pole piece 39 to extend rearward by a still reduced core width, 1.0 μm, for example, from the tip end exposed at the bottom surface 25, as compared with the aforementioned first embodiment. Like reference numerals are attached to the structures or components similar to those of the aforementioned first to third embodiments.

Ion milling process may be employed to form the reduced front end layer 64 and the front magnetic pole piece 39, for example. The ion milling process also serves to form a lower auxiliary magnetic pole piece 66 out of the lower magnetic pole layer 34. When the lower magnetic pole piece 66 is opposed to the front magnetic pole piece 39, a further narrower write gap can be established at the bottom surface 25. In forming the lower auxiliary magnetic pole piece 66, the upper magnetic pole layer 37 may be utilized as a photomask.

It should be noted any of the aforementioned thin film magnetic head 32, 32a-32c may be employed in any type of a magnetic recording medium drive including a magnetic disk drive and a magnetic tape drive other than the aforementioned HDD 11.

What is claimed is:

1. A thin film magnetic head comprising:
a non-magnetic gap layer;
an insulating layer extending over the non-magnetic gap layer;
a swirly coil pattern embedded in the insulating layer;
a lower magnetic pole layer extending below the non-magnetic gap layer from a central position of the coil pattern so as to expose a tip end at a medium-opposed surface; and
an upper magnetic pole layer extending from the central position of the coil pattern over a surface of the insulating layer so as to expose a tip end at the medium-opposed surface, wherein
a neck height of the upper magnetic pole layer near a trailing side is set equal to or less than 1.0 μm.

2. The thin film magnetic head according to claim 1, wherein said upper magnetic pole layer keeps getting narrower toward the tip end at least at a section near the trailing side until the tip end reaches the medium-opposed surface.

3. The thin film magnetic head according to claim 1, wherein the neck height near the trailing side is set smaller than a neck height near a leading side in the upper magnetic pole layer.

4. The thin film magnetic head according to claim 1, wherein said upper magnetic pole layer includes:
a primary magnetic core layer extending forward toward the medium-opposed surface so as to get narrower in a forward direction;
a front magnetic pole piece coupled to a front tip end of the primary magnetic core layer so as to expose its tip end at the medium-opposed surface, said front magnetic pole piece extending over a planar surface by a constant core width; and
a sectional plane defined at an interface between the front magnetic pole piece and the primary magnetic core layer so as to take an inclined attitude.

5. The thin film magnetic head according to claim 4, wherein said sectional plane intersects the medium-opposed surface.

6. The thin film magnetic head according to claim 1, further comprising an upper auxiliary magnetic pole piece disposed between the upper magnetic pole layer and the non-magnetic gap layer so as to extend rearward over the non-magnetic gap layer from a tip end exposed at the medium-opposed surface, said upper auxiliary magnetic pole piece having a reduced width smaller than a constant width of the tip end of the upper magnetic pole layer.

7. The thin film magnetic head according to claim 6, further comprising a lower auxiliary magnetic pole piece disposed between the lower magnetic pole layer and the non-magnetic gap layer so as to extend rearward over the lower magnetic pole layer from a tip end exposed at the medium-opposed surface, said lower auxiliary magnetic pole piece having a reduced width smaller than the constant width of the tip end of the upper magnetic pole layer.

8. The thin film magnetic head according to claim 1, wherein said upper magnetic pole layer has a surface exposed at the medium-opposed surface, said surface defined by a lower side contour extending by a first width along a boundary between the non-magnetic gap layer and the upper magnetic pole layer and an upper side contour extending by a second width larger than the first width.

9. A magnetic head assembly comprising:
a head slider defining a medium-opposed surface;
an elastic suspension supporting the head slider;
a lower magnetic pole layer formed on the head slider so as to extend along a plane intersecting the medium-opposed surface;
a non-magnetic gap layer extending over a surface of the lower magnetic pole layer;
an insulating layer extending over a surface of the non-magnetic gap layer;
a swirly coil pattern embedded in the insulating layer; and
an upper magnetic pole layer extending from the central position of the coil pattern over a surface of the insulating layer so as to expose a tip end at the medium-opposed surface, wherein
a neck height of the upper magnetic pole layer near a trailing side is set equal to or less than 1.0 μm.

10. The magnetic head assembly according to claim 9, wherein said upper magnetic pole layer keeps getting narrower toward the tip end at least at a section near the trailing side until the tip end reaches the medium-opposed surface.

11. The magnetic head assembly according to claim 9, wherein the neck height near the trailing side is set smaller than a neck height near a leading side in the upper magnetic pole layer.

12. The magnetic head assembly according to claim 9, wherein said upper magnetic pole layer includes:
a primary magnetic core layer extending forward toward the medium-opposed surface so as to get narrower in a forward direction;
a front magnetic pole piece coupled to a front tip end of the primary magnetic core layer so as to expose its tip end at the medium-opposed surface, said front magnetic pole piece extending over a planar surface by a constant core width; and
a sectional plane defined at an interface between the front magnetic pole piece and the primary magnetic core layer so as to take an inclined attitude.

13. The magnetic head assembly according to claim 12, wherein said sectional plane intersects the medium-opposed surface.

14. The magnetic head assembly according to claim 9, further comprising an upper auxiliary magnetic pole piece disposed between the upper magnetic pole layer and the non-magnetic gap layer so as to extend rearward over the non-magnetic gap layer from a tip end exposed at the medium-opposed surface, said upper auxiliary magnetic pole piece having a reduced width smaller than a constant width of the tip end of the upper magnetic pole layer.

15. The magnetic head assembly according to claim 14, further comprising a lower auxiliary magnetic pole piece disposed between the lower magnetic pole layer and the non-magnetic gap layer so as to extend rearward over the lower magnetic pole layer from a tip end exposed at the medium-opposed surface, said lower auxiliary magnetic pole piece having a reduced width smaller than the constant width of the tip end of the upper magnetic pole layer.

16. The magnetic head assembly according to claim 9, wherein said upper magnetic pole layer has a surface exposed at the medium-opposed surface, said surface defined by a lower side contour extending by a first width along a boundary between the non-magnetic gap layer and the upper magnetic pole layer and an upper side contour extending by a second width larger than the first width.
